(19) United States
(12) Patent Application Publication
(10) Pub. No.: US 2025/0317630 A1
(43) Pub. Date: Oct. 9, 2025

(54) MESSAGE PROCESSING METHOD AND APPARATUS, AND ELECTRONIC DEVICE AND STORAGE MEDIUM

(71) Applicant: DOUYIN VISION CO., LTD., Beijing (CN)

(72) Inventor: Yanyao CAO, Beijing (CN)

(21) Appl. No.: 18/865,334

(22) PCT Filed: Aug. 9, 2023
(86) PCT No.: PCT/CN2023/111874

§ 371 Date: Nov. 12, 2024

(30) Foreign Application Priority Data
Aug. 9, 2022 (CN) 202210951151.X

(51) Int. Cl. H04N 21/81; H04N 21/2187; H04N 21/4788

(52) U.S. Cl. CPC H04N 21/8146; H04N 21/2187; H04N 21/4788

(57) ABSTRACT

Embodiments of the present disclosure provide a message processing method and apparatus, an electronic device, and a storage medium. The method is applied to a first terminal and includes: receiving a target virtual object message; in response to that the target virtual object message is a virtual object message corresponding to the first terminal, adding the target virtual object message to a first message queue; and in response to that the target virtual object message is a virtual object message corresponding to a second terminal, adding the target virtual object message to a second message queue, in which a processing priority corresponding to the first message queue is higher than a processing priority corresponding to the second message queue.

The present application claims the priority to Chinese Patent Application No. 202210951151.X, filed on Aug. 9, 2022, the entire disclosure of which is incorporated herein by reference as portion of the present application.

### TECHNICAL FIELD

Embodiments of the present disclosure relate to a message processing method and apparatus, an electronic device, and a storage medium.

### BACKGROUND

With the rapid development of computer technology, video live streaming platforms based on smart terminals have been widely used, enriching people's daily lives. Users can watch live streaming videos through various live streaming platforms and interact with a live streamer of a live streaming video, such as sending virtual gifts to the live streamer. The virtual gifts sent by users are displayed in the gift tray on a live streaming interface. However, if a certain user among a large number of users watching the live streaming video continuously clicks a virtual gift icon on the live streaming interface to generate a combo message, and in response to that the number of consecutive clicks is too large or the user continues to send the combo message for an extended period, it may cause gift messages from other users other than this user to be blocked and unable to be displayed, thereby affecting the experience of other users watching the live streaming video.

### SUMMARY

To solve the above-mentioned technical problems, the present disclosure provides a message processing method.

In a first aspect, embodiments of the present disclosure provide a message processing method which is applied to a first terminal, and the method includes:
receiving a target virtual object message;
in response to that the target virtual object message is a virtual object message corresponding to the first terminal, adding the target virtual object message to a first message queue;
in response to that the target virtual object message is a virtual object message corresponding to a second terminal, adding the target virtual object message to a second message queue; and
a processing priority corresponding to the first message queue is higher than a processing priority corresponding to the second message queue.

In a second aspect, the embodiments of the present disclosure provide a message processing
apparatus which is applied to a first terminal, and the apparatus includes:
a receiving unit which is configured to receive a target virtual object message;
a first adding unit which is configured to, in response to that the target virtual object message is a virtual object message corresponding to the first terminal, add the target virtual object message to a first message queue; and
a second adding unit which is configured to, in response to that the target virtual object message is a virtual object message corresponding to a second terminal, add the target virtual object message to a second message queue, in which a processing priority corresponding to the first message queue is higher than a processing priority corresponding to the second message queue.

In a third aspect, the embodiments of the present disclosure provide an electronic device, including:
a memory;
a processor; and
a computer program,
in which the computer program is stored in the memory and is configured to be executed by the processor to implement the message processing method mentioned above.

In a fourth aspect, the embodiments of the present disclosure provide a computer-readable storage medium on which a computer program is stored, and the computer program is configured to be executed by a processor to implement the message processing method mentioned above.

### BRIEF DESCRIPTION OF DRAWINGS

The drawings herein are incorporated into and form a part of the specification, illustrate the embodiments consistent with the present disclosure, and are used in conjunction with the specification to explain the principles of the present disclosure.

In order to more clearly illustrate the embodiments of the present disclosure, the drawings to be used in the embodiments will be briefly described below, and it will be obvious to those ordinarily skilled in the art that other drawings can be obtained based on these drawings without inventive work.

FIG. 1 is a schematic flowchart of a message processing method provided by the embodiments of the present disclosure;

FIG. 2 is a schematic diagram of an application scenario provided by the embodiments of the present disclosure;

FIG. 3 is a schematic diagram of a display interface provided by the embodiments of the present disclosure;

FIG. 4 is a schematic flowchart of a message processing method provided by the embodiments of the present disclosure;

FIG. 5 is a schematic flowchart of a message processing method provided by the embodiments of the present disclosure;

FIG. 6 is a schematic diagram of another display interface provided by the embodiments of the present disclosure;

FIG. 7 is a schematic flowchart of a message processing method provided by the embodiments of the present disclosure;

FIG. 8 is a schematic flowchart of a message processing method provided by the embodiments of the present disclosure;

FIG. 9 is a schematic structural diagram of a message processing apparatus provided by the embodiments of the present disclosure; and

FIG. 10 is a schematic structural diagram of an electronic device provided by the embodiments of the present disclosure.

### DETAILED DESCRIPTION

In order to understand the above-mentioned objects, features and advantages of the present disclosure more clearly, the solutions of the present disclosure will be further described below. It should be noted that, in case of no conflict, the features in one embodiment or in different embodiments can be combined.

Many specific details are set forth in the following description to fully understand the present disclosure, but the present disclosure can also be implemented in other ways different from those described here: obviously, the embodiments in the specification are a part but not all of the embodiments of the present disclosure.

With the rapid development of Internet technology and streaming media technology, live streaming has gradually been widely used, and more and more users are experiencing online interaction with live streamers in live streaming rooms, such as giving virtual gifts. In response to that users want to give virtual gifts to the live streamers, they can click a gift icon on a display screen of a terminal watching the live streaming; after clicking the gift icon, a combo message will be generated, and the combo message will be transmitted to a back-end server, and then the server will return the collected combo message of each user watching the live streaming to a corresponding gift tray in the live streaming room; the gift tray is used to display the combo message on each terminal, that is, to display a virtual gift effect, and the gift tray, upon being triggered by the combo message, displays information such as the username of the user sending the virtual gift, gifts, and the quantity of gifts; the quantity of gifts may also be understood as the combo count, which increases as the gift tray receives combo messages (for example, the combo count may also represent the number of consecutive times a user clicks on the gift icon), for example, the current combo count increments by 1 up to the target combo count, where the target combo count represents the number of virtual gifts sent by the user; and in response to that the combo count is too large or the user continues to send combo messages for an extended period, the combo messages will be displayed in the live streaming room for a long time, so that combo messages of other users watching the live streaming cannot be displayed in time, or they may not be displayed at all, resulting in a poor interaction experience for users within the live streaming room.

At present, displaying the combo message by the gift tray is that a combo group identifier (ID) in the current combo message is recorded through each gift tray; after the combo message arrives, the current gift tray is inquired; in response to that the combo group identifier is matched with a combo group identifier of the currently displayed combo message, the combo message will be directly transmitted to the gift tray; that is, the combo messages transmitted by the same user is continuously displayed; therefore, the target combo count of the gift tray is refreshed; for example, the gift tray is currently displaying the combo count of the virtual gift, incrementing from 1 until reaching the target combo count of 10, at the moment, after the gift tray is inquired, a new combo message is sent to the gift tray, and in response to that the target combo count in the combo message is 15, this will continue incrementing based on the previous target combo count of 10, until the displayed target combo count reaches 25, and then the display will end. The gift tray continuously increments the current combo count by 1; and when the target combo count of the gift tray is reached and no combo messages with the same combo group identifier are received within 2 to 3 seconds, exiting will be performed. In summary, there are two processes; new combo messages first query the gift tray and then wait after the combo message display ends; in response to that combo messages are first sent to the gift tray, it will cause all combo messages from the same user to block the combo messages from other users; and in response to a certain user continuously sends the same type of gift, the combo message of this user will be continuously displayed, so that the combo messages of other users cannot be displayed, and the live streaming interaction experience of other users will be influenced.

In view of the above-mentioned technical problems, the embodiments of the present disclosure provide a message processing method which is applied to a first terminal. The method includes: receiving a target virtual object message, and adding the target virtual object message to a first message queue in response to that the target virtual object message is a virtual object message corresponding to the first terminal; and in response to that the target virtual object message is a virtual object message corresponding to a second terminal, that is, the target virtual object message does not correspond to the first terminal and corresponds to other terminals except the first terminal in the same live streaming room, adding the target virtual object message to a second message queue, in which the processing priority corresponding to the first message queue is higher than the processing priority corresponding to the second message queue. The method provided in the present disclosure adds messages to message queues with different processing priorities respectively, effectively avoiding the problem of the terminal's own corresponding messages being blocked and unable to be displayed, thereby enhancing the user's watching experience. Detailed description is carried out through the following one or more embodiments.

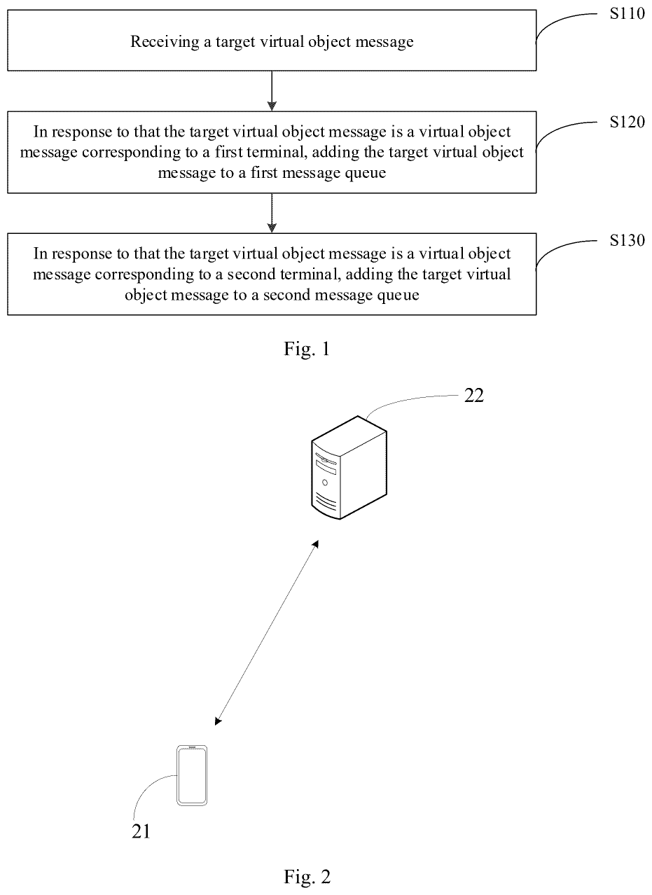

FIG. 1 is a schematic flowchart of a message processing method provided by the embodiments of the present disclosure, which is applied to a first terminal. The message processing method includes the following steps S110 to S130 shown in FIG. 1.
S110, receiving a target virtual object message.

The virtual object may be a virtual gift, such as a gift sent to a live streamer by a user in a live streaming room, and the target virtual object may be a currently received virtual object. The virtual object message includes combo group information and virtual object information.

Exemplarily, referring to FIG. 2, FIG. 2 is a schematic diagram of an application scenario provided by the embodiments of the present disclosure. The message processing method is executed by a terminal 21; an application program is configured on the terminal 21, and the application program has related functions of watching live streaming and receiving and sending virtual object messages; the terminal 21 may send a virtual object sending request to a back-end server 22 through the application program, and may also receive a virtual object message sent by the server 22; and the terminal 21 may display received virtual object messages on an interface for watching the live streaming through a gift tray. It should be understood that each terminal in communication connection with the server 22 may generate a corresponding virtual object sending request after receiving a trigger operation on a gift icon on its respective display interface, and the virtual object sending request includes related information of the terminal and the gift; then the virtual object sending request is sent to the server 22; and after receiving a large number of virtual object sending requests for the same live streaming room, the server 22 will forward virtual object messages corresponding to the large number of virtual object sending requests for the same live streaming room to each terminal in the same live streaming room.

Optionally, the terminal includes a gift tray system, which includes a tray queue class and a tray controller. The tray queue class is used to store all virtual object messages generated in the live streaming room; a tray queue may be understood as a message queue; and the tray controller is used to display the virtual object messages in the tray queue class on a display screen of the terminal. The tray queue class may be divided into a second tray queue (a second message queue) and a first tray queue (a first message queue); the second message queue is used to store virtual object messages sent by other terminals; the first message queue is used to store virtual object messages sent by the terminal itself; and the message processing priority corresponding to the first message queue is higher than the message processing priority of the second message queue.

It may be understood that in the gift tray system, the tray queue class is marked as Tray Queue, the tray controller is marked as Channel, the first message queue is marked as mSelfQueue, and the second message queue is marked as mOthersQueue; the tray queue class further includes an array list, a plurality of messages which can be used for displaying are placed in the array list, the messages in the array list will be sent to the tray controller after the tray controller controls the displayed messages to be displayed, and the array list is marked as mChannelList; receiveMsg in the tray queue class is an overall entry of the tray; and the server connected with the terminal sends the messages to the gift tray system of the terminal through the receiveMsg. The tray queue class further includes a calling method, referred to as try ConsumeQueue, which is the method invoked when triggering queue consumption. The method may select a message and hands it over to the tray controller for display. The tray queue class further includes an inquiry method. referred to as try PushContinuueMsg, and when tray combo is finished, the inquiry method may query the queue and try to continue displaying gift combo animation of the same combo group. The tray queue class further includes a discarding method, referred to as popFirstItem, and the first message in the queue is discarded. The tray queue class further includes a first selection method, referred to as fetch FirstMessage, and the first message which can be consumed in the messages is selected. The tray queue class further includes a second selection method, referred to as fetchFirstNone VideoMessage, and the first non-video gift message which can be consumed in the messages is selected.

For example, a user A watches live streaming through a terminal A (first terminal), and sends a virtual object message to the server in the live streaming room, in which the virtual object message is a combo message that the user A sends a virtual gift to a live streamer in the live streaming room; the server may receive a large number of virtual object messages sent by users watching the live streaming at the same time, and distributes the large number of virtual object messages to the terminals of all the users watching the live streaming; and the live streaming room of each terminal displays the received large number of virtual object messages, but the sequences of the virtual object messages displayed by all the terminals may be different. The following embodiment will describe by taking the terminal A used by the user A to execute the message processing method provided by the present disclosure as an example, the terminal itself refers to the terminal A, and the other terminals (for example, second terminal) refer to the other terminals except the terminal A among all the terminals watching the live streaming A. Specifically, the user A watches the live streaming A through the terminal A, the second message queue is used to store the virtual object messages sent by the other terminals except the terminal A among all the terminals watching the live streaming A, that is, the virtual object messages sent by the other terminals for the terminal A, and the first message queue is used to store the virtual object messages sent by the terminal A itself. It should be understood that for each terminal watching the live streaming A, there are a second message queue and a first message queue, that is, the relationship between the second message queue, the first message queue and the terminal is relative, for example, for a terminal B watching the live streaming A, the terminal A is another terminal, the virtual object messages of the terminal B are stored in the first message queue, and the virtual object messages of the terminal A are stored in the second message queue.

It may be understood that the first terminal receives at least one target virtual object message sent by the server; the virtual object message includes combo group information and virtual object information; the combo group information is a group of information generated after the user continuously clicks an icon of a virtual gift displayed on the terminal for multiple times, and the combo group information includes a user icon, a combo group icon, a virtual object icon and a live streamer icon; the user icon is an icon of the user watching live streaming by the terminal and sends a combo gift, so that whether the virtual object message is sent by the first terminal or not may be conveniently determined; the combo group icon may be understood as an icon of the virtual object message, so that whether the virtual object message with the same combo group icon exists in a queue or not may be conveniently determined; the virtual object icon is an icon of a specific gift selected by the user in gift icons of the terminal, such as an icon of a virtual gift like love; and the live streamer icon is an icon of a live streamer in live streaming, so that which live streaming room the virtual object message is displayed in is determined, and then the gift tray is determined. The virtual object information is display content related to the virtual gift to be displayed by the terminal, namely, the animation which can be watched by the user through the terminal; the virtual object information may be video-type information or non-video-type information; the video-type information may be in a multimedia computer file format (mp4), such as a dynamic effect of a virtual object like rose; and the non-video-type information include image and text information, such as information of displaying the user A, the virtual object love, the combo count of the virtual object and the like at the same time.
S120, in response to that the target virtual object message is a virtual object message corresponding to a first terminal, adding the target virtual object message to a first message queue.
S130, in response to that the target virtual object message is a virtual object message corresponding to a second terminal, adding the target virtual object message to a second message queue.

The processing priority corresponding to the first message queue is higher than the processing priority corresponding to the second message queue, that is, the virtual object messages in the first message queue are preferentially processed and displayed.

It should be understood that the target virtual object message being the virtual object message corresponding to the first terminal may also be the target virtual object message being a virtual object message corresponding to a virtual object sending request sent by the first terminal. The target virtual object message being the virtual object message corresponding to the second terminal may also be the target virtual object message being the virtual object message corresponding to the virtual object sending request sent by the second terminal. The first message queue may be a queue used by the first terminal for storing the virtual object messages corresponding to the terminal, and the second message queue may be a queue used by the first terminal for storing the virtual object messages corresponding to other terminals. Based on S110, determining whether the target virtual object message is the virtual object message corresponding to the first terminal itself according to target combo group information in the target virtual object message may be that determining whether the target virtual object message is the virtual object message corresponding to the first terminal itself according to the user icon in the target combo group information. In response to determining that the target virtual object message is not the target virtual object message corresponding to the first terminal itself, it is indicated that the target virtual object message is the target virtual object message corresponding to another terminal (such as the second terminal), and in this case, the target virtual object message is directly added to the second message queue.

Optionally, in response to that the target virtual object message is a virtual object message corresponding to the second terminal, adding the target virtual object message to the second message queue of the first terminal includes: in response to determining that the target virtual object message is the virtual object message corresponding to the second terminal according to target combo group information, determining whether a historical virtual object message corresponding to the target virtual object message exists in the second message queue of the first terminal, in which historical combo group information included in the historical virtual object message corresponding to the target virtual object message is identical to the target combo group information; and in response to that historical virtual object message corresponding to the target virtual object message does not exist in the second message queue, directly adding the target virtual object message to the second message queue of the first terminal.

It should be understood that in the above-mentioned S130, adding the target virtual object message to the second message queue may include the following steps: in response to determining that the target virtual object message is sent by the second terminal according to the user icon in target combo group information, determining whether a historical virtual object message which is identical to the target combo group information exists in a plurality of historical virtual object messages pre-stored in the second message queue; that is, the received target virtual object message and the historical virtual object message have the same combo group information, specifically, the same user icon, virtual object icon and live streamer icon are included, but the combo count of the virtual object icon may be different; for example, the virtual object message received by the terminal A (first terminal) is sent by a terminal (the second terminal) of a user B, the virtual object message is to give 10 virtual roses, other historical virtual object messages sent by the user B and stored in the second message queue are to give 5 virtual roses, and in this case, except for the number of the virtual roses is different, the rest of information is the same. In response to that the historical combo group message which is identical to the target combo group information does not exist in the second message queue, the target virtual object message is directly added to a proper position of the second message queue; and in response to that the historical combo group message which is identical to the target combo group information exists in the second message queue, the target virtual object message and the historical virtual object message are merged, specifically, the combo count in the target virtual object message and the combo count in the historical virtual object message can be merged, and other information is not changed.

Optionally, the method further includes: in response to that the historical virtual object message corresponding to the target virtual object information exists in the second message queue, taking out the historical virtual object message corresponding to the target virtual object information from the second message queue; determining a target combo count corresponding to a target virtual object based on the target virtual object message and the historical virtual object message corresponding to the target virtual object information, and updating a combo count in the target virtual object message according to the target combo count corresponding to the target virtual object, thereby obtaining an updated target virtual object message; and adding the updated target virtual object message to the second message queue of the first terminal.

It should be understood that in response to that the historical virtual object message corresponding to target virtual object information exist in the second message queue, and the historical combo group message which is identical to the target combo group information exists in the historical virtual object message corresponding to the target virtual object information, merging the target virtual object message and the historical virtual object message may include: taking out the historical virtual object message corresponding to the target virtual object information from the second message queue, and obtaining a total target combo count according to the combo count in the target virtual object message and the historical virtual object message corresponding to the target virtual object information (hereinafter referred to as the historical virtual object message), for example, obtaining the target combo count by adding the combo counts in the target virtual object message and the historical virtual object message, in which the historical virtual object message is a message that has not been displayed, messages stored in each message queue are messages that have not yet been displayed, the queue may move the messages to be displayed to an array list or directly to the tray controller, and after the messages are moved, the messages do not exist in the queue. After the target combo count is determined, the combo count in the received target virtual object message is updated according to the target combo count, that is, only the combo count is updated, other information is not updated, or only the combo count in the historical virtual object message is updated to obtain updated virtual object information; and the updated virtual object message is added to a proper position of the second message queue of the first terminal. Through the method provided by the present disclosure, the combo group information does not need to be acquired by inquiring the tray controller through the queue, the tray controller does not need to wait, and the blocking phenomenon in the message display process can be effectively reduced only by integrating the messages that have not been displayed.

Optionally, in response to determining that the virtual object message to be displayed does not exist in the first message queue, the virtual object message to be displayed in the second message queue is displayed.

For example, in response to determining that the virtual object message to be displayed does not exist in the first message queue of the first terminal, the first virtual object message to be displayed in the second message queue is sent to the tray controller of the first terminal, and the tray controller is used to control virtual object information in the first virtual object message to be displayed to display.

It should be understood that before the virtual object message to be displayed is determined, for example, whether the virtual object message to be displayed exists in the first message queue or not is preferentially determined; the virtual object message corresponding to the first terminal itself is stored in the first message queue, that is, whether there are any virtual object messages corresponding to the first terminal itself is preferentially determined; in response to that the virtual object message to be displayed does not exist in the first message queue, the message in the second message queue may be displayed at the moment, and the first virtual object message in the second message queue is sent to the tray controller; the first virtual object message may not be the virtual object message added to the second message queue in the above-mentioned S130, and may be another virtual object message pre-stored in the second message queue; that is, in response to that a new virtual object message is stored in the second message queue, the second message queue needs to sort the virtual object messages again, and the first virtual object message in the second message queue after being sorted again is sent to the tray controller; the tray controller is used to control the virtual object information in the first virtual object message to display, that is, the tray controller controls the gift tray in the terminal to display the first virtual object message; and the message processing priority corresponding to the first message queue is higher than that of the second message queue; that is, for each terminal watching live streaming, the message displaying/processing priority of the first message queue storing the message of the terminal itself is higher than that of the second message queue storing the messages of other terminals; that is, for each terminal, the message sent by the terminal itself is preferentially displayed/processed; and after the display of the message of the terminal itself is finished, the messages sent by other terminals are displayed.

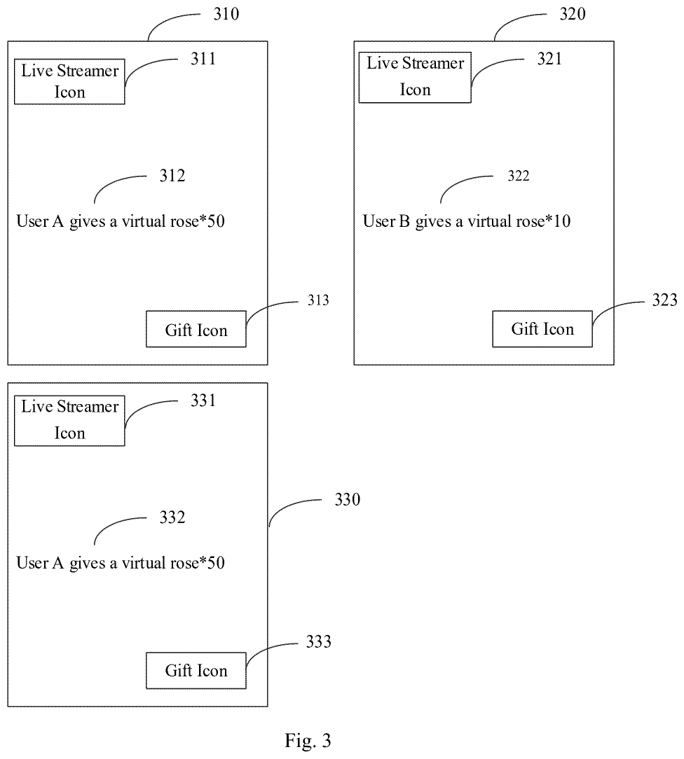

Exemplarily, referring to FIG. 3. FIG. 3 is a schematic diagram of a display interface provided by the embodiments of the present disclosure; a live streaming interface 310 in FIG. 3 includes an live streamer icon 311, virtual object information 312 and a gift icon 313; the live streaming interface 310 may be a live streaming interface displayed by the terminal A; the virtual object information 312 displayed by the live streaming interface 310 is in the virtual object message sent by the terminal A; the live streaming icon 311 is used to display the live streamer of the live streaming room watched by the terminal A; the user of the terminal A can generate a virtual object message by clicking the gift icon 313; the virtual object information 312 displayed by the live streaming interface 310 is “user A gives a virtual rose*50”; and the live streaming interface 310 displays a message that the user A using the terminal A gives a gift. FIG. 3 further includes a live streaming interface 320, and the live streaming interface 320 also includes a live streamer icon 321, virtual object information 322 and a gift icon 323; the live streaming interface 320 is a live streaming interface displayed by the terminal B, and the display moments of the live streaming interface 320 and the live streaming interface 310 are the same, that is, the display moment at which user A, through terminal A, watches the live streaming interface is identical to the display moment at which user B, through terminal B, watches the live streaming interface; the live streamer icon 321 and the gift icon 323 are identical to the live streamer icon 311 and the gift icon 313; the virtual object information 322 displayed in the live streaming interface 320 at the same moment is “user B gives a virtual rose*10”, and the message sent by the terminal B itself is preferentially displayed, not the message sent by the terminal A; and the terminal B may display the virtual object information 312 according to the sequence after displaying the virtual object information 322, that is, the virtual object messages displayed by the live streaming interfaces of different terminals may be different at the same moment, and the sequences of the displayed virtual object messages may be different. FIG. 3 further includes a live streaming interface 330; the live streaming interface 330 also includes a live streamer icon 331, virtual object information 332 and a gift icon 333; the live streaming interface 330 may be a live streaming interface displayed by a terminal C, and the virtual object information 332 displayed in the live streaming interface 330 is “user A gives a virtual rose*50”; for the terminal C, the virtual object messages sent by the terminal A and the terminal B belong to messages sent by other terminals; the virtual object messages sent by the terminal A and the terminal B are respectively stored in the second message queue of the terminal C, but the storage sequences in the second message queue are different, and the display sequences are also different; the virtual object message sent by the terminal A in the second message queue of the terminal C is arranged before the virtual object message sent by the terminal B, so that the terminal C preferentially displays the virtual object message sent by the terminal A; and in response to that the second message queue of the terminal C only includes two virtual object messages, after the virtual object message sent by the terminal A is displayed, the virtual object message sent by the terminal B is displayed.

Optionally, after the virtual object message is displayed, and in response to that the currently displayed virtual object message is of a video type, a next virtual object message to be displayed of a non-video type is acquired in the second message queue or the first message queue, and the next virtual object message to be displayed is displayed; or, in response to that the currently displayed virtual object message is of the non-video type, the next virtual object message to be displayed is acquired in the second message queue or the first message queue, and the next virtual object message to be displayed is displayed.

Optionally, the terminal includes a plurality of tray controllers. The method further includes: in response to that the virtual object information, controlled by any one of the tray controllers to be displayed, in the virtual object message is information of the video type, acquiring a next target virtual object message which is of the non-video type and is not controlled by other tray controllers to be displayed in the second message queue or the first message queue, and transmitting the next target virtual object message to a tray controller, in an idle state, among the tray controllers; or, in response to that the virtual object information controlled by any one of the tray controllers to be displayed is the information of the non-video type, acquiring a next target virtual object message which is not controlled by other tray controllers to be displayed in the second message queue or the first message queue, and transmitting the next target virtual object message to a tray controller, in the idle state, among the tray controllers.

It should be understood that each terminal may include a plurality of tray controllers, for example, the first terminal includes two tray controllers; in response to that the virtual object information controlled by any one of the plurality of tray controllers to be displayed is information of the video type, for example, the information displayed by a gift tray controlled by the first tray controller among the two tray controllers is the information of video type, for example, a video effect in an MP4 format; in this case, the virtual object message controlled by the second tray controller to be displayed cannot be information of video type, information of non-video type needs to be acquired in the second message queue or the first message queue, and target virtual object message controlled by other tray controllers to be displayed is not needed; in response to that the first message queue includes the virtual object message of the information of non-video type, the virtual object message is directly used as the next target virtual object message; and in response to that the first message queue does not include the virtual object message of the information of non-video type, the virtual object information of the information of non-video type is selected in the second message queue. According to a possible selection mode, in the second message queue, the first in order is a virtual object message including the information of video type, and the second in order is a virtual object message including information of non-video type, and in this case, the virtual object message that is second in order serves as a next target virtual object message; after determining the next target virtual object message, the next target virtual object message is transmitted to a tray controller, in the idle state, among the plurality of tray controllers; the idle state refers to that no virtual object message needing to be controlled to be displayed exists at present; for example, the next target virtual object message is transmitted to the second tray controller, the second tray controller controls the gift tray to display the next target virtual object message including the information of non-video type; at the moment, the live streaming interface of the terminal can simultaneously display the information of the video type controlled by the first tray controller to be displayed and the information of the non-video type controlled by the second tray controller to be displayed; it should be understood that two gift trays cannot display the information of the video type at the same time, but can display the information of one video type and the information of one non-video type, and can also display the information of two non-video types at the same time; that is, only one tray controller among the plurality of tray controllers included in the terminal can display the information of the video type at the same time; or in response to that the virtual object information controlled by any tray controller among the plurality of tray controllers to be displayed is the information of non-video type, the target virtual object information controlled by another tray controller to be displayed in the second message queue and/or the first message queue is acquired, and the target virtual object information is transmitted to a tray controller, in the idle state, among the plurality of tray controllers, that is, the two tray controllers can control the virtual object information to be displayed at the same time.

The message processing method provided by the embodiments of the present disclosure is applied to a first terminal, and includes: receiving a target virtual object message, in which the target virtual object message includes target combo group information and target virtual object information; in response to that the virtual object message is a virtual object message corresponding to the first terminal, adding the virtual object message to a first message queue of the first terminal; in response to determining that the virtual object message is a virtual object message corresponding to the second terminal according to the combo group information, that is, the virtual object message is not corresponding to the terminal itself and is corresponding to another terminal, adding the virtual object message to a second message queue of the first terminal, in which the second message queue is used to store messages sent by other terminals; in response to that the first message queue of the first terminal is determined not to have the virtual object message, and the first message queue is used to store the message sent by the terminal itself, in this case, sending the first virtual object message in the second message queue to a tray controller of the first terminal, in which the tray controller is used to control the virtual object information in the first virtual object message to be displayed; and the message processing priority corresponding to the first message queue is higher than that of the second message queue, that is, the message sent by the terminal itself is preferentially displayed in the display screen of the first terminal, so that the problem that the message sent by the terminal itself is blocked and cannot be displayed is effectively avoided, and the user experience of the terminal is improved.

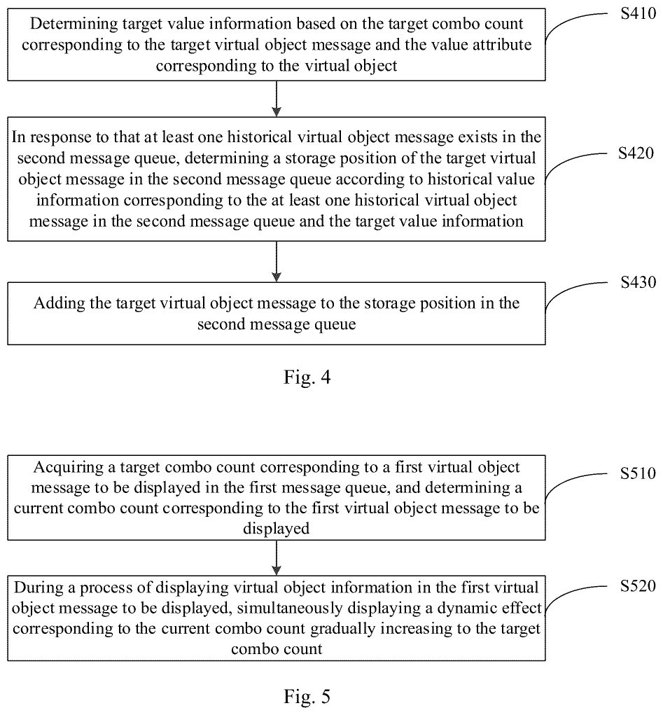

Based on the above-mentioned embodiment, FIG. 4 is a schematic flowchart of a message processing method provided by the embodiments of the present disclosure; optionally, adding the target virtual object message to the second message queue of the first terminal includes the following steps S410 to S430 shown in FIG. 4.
S410, determining target value information based on the target combo count corresponding to the target virtual object message and the value attribute corresponding to the virtual object.

It should be understood that the mode of adding the target virtual object message to the proper position of the second message queue may include the following steps: acquiring a target combo count of the target virtual object message, in which the target combo count may be understood as the total number of given virtual objects; acquiring the value attribute corresponding to each virtual object, in which the value attribute may be understood as the value corresponding to each virtual object, namely the unit price, and may be understood as the value of each virtual gift; obtaining target value information by calculating the product of the target combo count and the value attribute, in which the target value information may be understood as the total value of all virtual objects involved in the virtual object message, namely the total price.
S420, in response to that at least one historical virtual object message exists in the second message queue, determining a storage position of the target virtual object message in the second message queue according to historical value information corresponding to the at least one historical virtual object message in the second message queue and the target value information.

It should be understood that based on the S410, in response to that at least one historical virtual object message exists in the second message queue, after the total value corresponding to the target virtual object is determined, historical value information corresponding to each historical virtual object message in at least one historical virtual object message pre-stored in the second message queue of the first terminal is compared with the target value information, that is, sorting is performed according to the sizes of the historical value information corresponding to the historical virtual object messages included in the second message queue and the target value information, and the storage position of the target virtual object message in the second message queue is determined. For example, two virtual object messages are pre-stored in the second message queue, value information corresponding to the two virtual object messages is 8 and 6 respectively, and the target value information is 7; and the target value information 7 and the value information 6 and 8 corresponding to the two virtual object messages are sorted, a second sequence of the target virtual object message corresponding to the target value information in the second message queue can be determined, and the first virtual object message in the second message queue is a virtual object message with the numerical value of 8, that is, the storage position of the received target virtual object message in the second message queue is determined.

Optionally, the determining the storage position of the target virtual object message in the second message queue according to the historical value information corresponding to at least one historical virtual object message in the second message queue and the target value information includes: sorting the historical value information corresponding to at least one historical virtual object message in the second message queue and the target value information; during the sorting process, in response to that there exists target historical value information identical to the target value information, acquiring a generation time of a target virtual object message corresponding to the target value information and a generation time of a historical virtual object message corresponding to the historical value information identical to the target value information; and determining the storage position of the target virtual object message in the second message queue according to the generation time of the target virtual object message and the generation time of the historical virtual object message.

It should be understood that determining the storage position of the target virtual object message in the second message queue may include the following steps: sorting the historical value information corresponding to at least one historical virtual object message pre-stored in the second message queue and the target value information, in which the historical value information and the target value information may be sorted in a descending order, the virtual object message with a large value is arranged at the front of the second message queue, and the specific sorting mode may be determined based on user requirements; during the sorting process, in response to that target historical value information identical to the target value information exists in the historical value information corresponding to the at least one historical virtual object message, acquiring the generation time of the virtual object messages corresponding to the target value information and the target historical value information respectively; that is, in response to that the virtual object messages with the same value exist, acquiring the generation time of the virtual object messages with the same value, the generation time referring to the time for generating the messages by the terminal; sorting the virtual object messages respectively corresponding to the target value information and the target historical value information according to the generation time of the target virtual object message and the generation time of the historical virtual object message; determining the storage position of the target virtual object message in the second message queue, that is, sorting the virtual object messages with the same value according to the time sequence after sorting according to the value; for example, in response to that the value corresponding to one virtual object message is identical to the target value information, sorting the two virtual object messages according to the time sequence, and sorting the other messages according to the value. In conclusion, the sorting principle is that sorting is carried out according to the value firstly, and then the messages with the same value are sorted according to the time sequence.

S430, adding the target virtual object message to the storage position in the second message queue.

It should be understood that based on the above-mentioned S420, after determining the storage position of the received target virtual object message in the second message queue, the target virtual object message is added to the storage position of the second message queue.

The embodiments of the present disclosure provide the message processing method, which includes: calculating the target value information corresponding to the received target virtual object message, sorting according to historical value information corresponding to at least one virtual object message pre-stored in the second message queue and the target value information, and determining the storage position of the received target virtual object message in the second message queue, so that respective messages in the second message queue are convenient to manage, the corresponding message with relatively high value is preferentially displayed, and the live streaming interaction experience of the user is further improved.

Based on the above-mentioned embodiment, FIG. 5 is a schematic flowchart of a message processing method provided by the embodiments of the present disclosure, optionally, after adding the target virtual object message to the first message queue of the first terminal, displaying virtual object messages to be displayed in the first message queue includes the following steps S510 to S520 shown in FIG. 5.

It should be understood that in response to determining that the target virtual object message corresponds to the first terminal itself, the target virtual object message is added to the first message queue, the first message queue is used to store the message corresponding to the first terminal, so that the message is conveniently displayed in a live streaming interface of the first terminal in time. Specifically, the first virtual object message after message sorting in the first message queue may be sent to a tray controller in the idle state, the tray controller controls the virtual object information in the virtual object message to be displayed on the live streaming interface of the first terminal, that is, the messages in the first message queue are preferentially displayed, and the first virtual object message may be the currently received target virtual object message.
S510, acquiring a target combo count corresponding to a first virtual object message to be displayed in the first message queue, and determining a current combo count corresponding to the first virtual object message to be displayed.
S520, during a process of displaying virtual object information in the first virtual object message to be displayed, simultaneously displaying a dynamic effect corresponding to the current combo count gradually increasing to the target combo count.

For example, the tray controller being used to control the display of the virtual object information in the virtual object message includes: acquiring, by the tray controller, a target combo count in a first (top) virtual object message after message sorting in the first message queue; and determining a current combo count corresponding to the first virtual object message to be displayed, and in the process of controlling the display of the virtual object information in the first virtual object message, simultaneously displaying a dynamic effect in which an accumulated number is obtained by accumulating a preset value based on the current combo count and the accumulating is stopped until the accumulated number reaches the target combo count.

It should be understood that the tray controller acquires the target combo count of the first virtual object message to be displayed, the target combo count may be understood as the total number of virtual objects to be displayed; the current combo count corresponding to the first virtual object message to be displayed is determined; in a possible scenario, the currently displayed virtual object is not sent by the first terminal or is different from the virtual object in the first virtual object message to be displayed; for example, the currently displayed virtual object is a virtual love, the virtual object in the first virtual object message to be displayed is a virtual rose, the target combo count corresponding to the first virtual object message to be displayed is the total number 10 of the virtual rose, and the current combo count corresponding to the first virtual object message to be displayed is 1, that is, the virtual rose*1 is gradually increased by 1 until the virtual rose*10 is displayed. In another possible scenario, for a currently displayed virtual object message 1 corresponding to the first terminal, the currently displayed dynamic effect is virtual rose*5, the display of the virtual object message 1 is finished, then the first virtual object message to be displayed corresponding to the first terminal is displayed, the first virtual object message to be displayed is also virtual rose, the target combo count is 10, that is, after the first terminal sends 5 virtual roses, 10 virtual roses are further sent, the current combo count corresponding to the first virtual object message to be displayed determined at the moment is 6, 1 is added based on the last displayed virtual rose*5, the virtual rose*6 is displayed, 1 is added in sequence until the virtual rose*15 is displayed, that is, the number of virtual objects is displayed in an accumulated manner for the same virtual object message sent by the first terminal. During the process of controlling the display of the virtual object information in the first virtual object message to be displayed, the accumulated number obtained by accumulating the preset value based on the current combo count is displayed at the same time until the accumulated number reaches the target combo count; the preset value may be 1, that is, for the message corresponding to the terminal itself, the number after 1 is accumulated each time is displayed, and for the message corresponding to the terminal itself, the displayed combo count cannot jump, so after the animation of each combo count jump is finished, 1 is added to the current combo count and the current combo count is compared with the target combo count; in response to that the target combo count is not reached, the combo count jump animation is continuously displayed, the process is circulated until the end, for example, a live streaming interface displays “user A gives virtual rose*1”, then “user A gives virtual rose*2” is displayed, then “user A gives virtual rose*3” is displayed, and the display is finished until the “user A gives virtual rose*10” is displayed.

Optionally, the tray controller is used to control virtual object information in virtual object messages to be displayed, and displaying the virtual object messages in the second message queue includes: acquiring, by the tray controller, the target combo count in the first virtual object message to be displayed in the second message queue, and simultaneously displaying the target combo count during the process of controlling the display of the virtual object information in the first virtual object message to be displayed.

It should be understood that in response to that the tray controller controls the display of the first virtual object message (the first virtual object message to be displayed) in the second message queue after message sorting, the tray controller may directly acquire the target combo count in the first virtual object message; during the process of controlling the display of the virtual object information in the first virtual object message, the target combo count is displayed simultaneously; that is, for the terminal A, in response to that the message not sent by the user is displayed, the target combo count is directly displayed; that is, direct jumping is carried out, and non-accumulative display is performed; for example, in response to that the target combo count in the first virtual object message is 10, the tray controller directly displays a piece of information “user B gives virtual rose*10” on the live streaming interface, the information is not displayed in an accumulated mode as the terminal message in the above example, and the current combo count determined by the tray controller at the beginning is the target combo count in the virtual object message; and after the animation of each time of combo count jumping is finished, the current combo count is directly set as the target combo count, so that the blocking phenomenon can be effectively reduced.

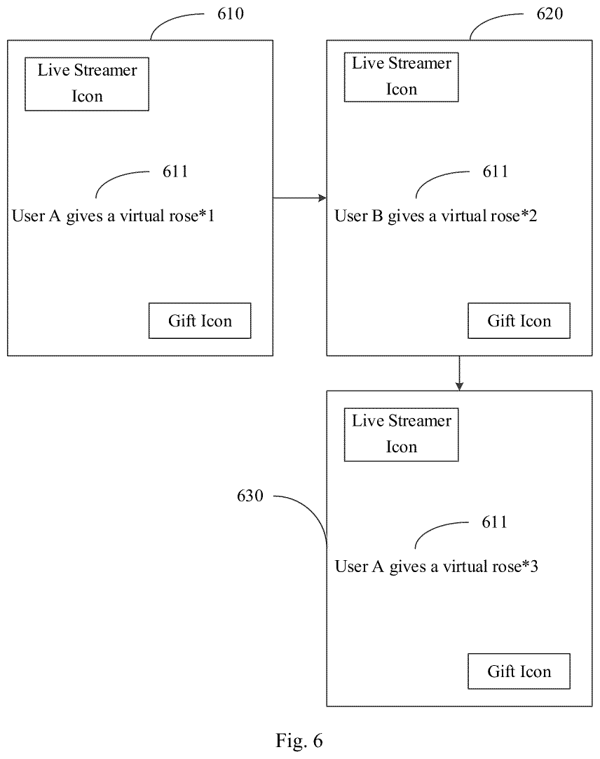

Exemplarily, referring to FIG. 6, FIG. 6 is a schematic diagram of another display interface provided by the embodiments of the present disclosure; the display process of displaying the live streaming interface of the message sent by the terminal A is displayed in FIG. 6; FIG. 6 includes a live streaming interface 610; the live streaming interface 610 is a live streaming interface of the terminal A; the live streaming interface 610 includes virtual object information 611; the target combo count included in the virtual object information 611 is 3; the live streaming interface of the terminal A may display the current combo count in an accumulated mode, for example, the virtual object information 611 displays “user A gives virtual rose*1; FIG. 6 further includes a live streaming interface 620, the virtual object information 611 in the live streaming interface 620 displays “user A gives virtual rose*2; and FIG. 6 further includes the live streaming interface 630. the virtual object information 611 in the live streaming interface 630 displays “user A gives virtual rose*3.

The embodiments of the present disclosure provide the message processing method. For each first terminal displaying the live streaming interface, in response to that the live streaming interface is to display the virtual object message corresponding to the first terminal itself, the current combo count is displayed in an accumulative manner until the current combo count is identical to the target combo count in the virtual object message, and the display is ended; and in response to that the live streaming interface is not to display the virtual object message corresponding to the first terminal itself, that is, the live streaming interface is to display the virtual object message sent by the second terminal, the current combo count is directly equal to the target combo count, that is, direct jumping is carried out, and the accumulative display is avoided, so that the blockage phenomenon can be avoided.

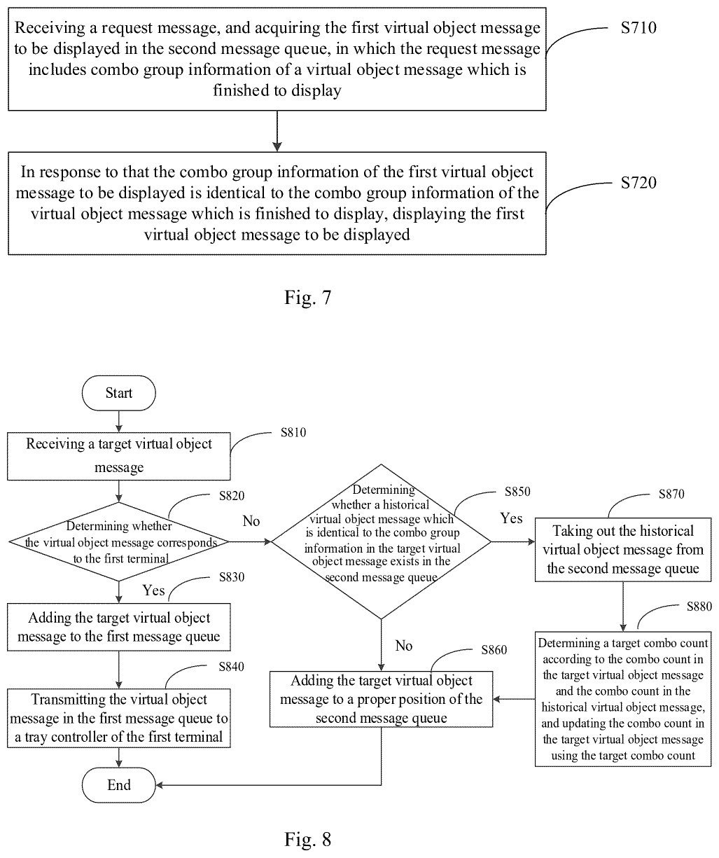

Based on the above-mentioned embodiments, FIG. 7 is a schematic flowchart of a message processing method provided by the embodiments of the present disclosure; after the tray controller controls the display of the virtual object information currently in the display state to be ended, the method further includes the following steps S710 to S720 shown in FIG. 7.

S710, receiving a request message, and acquiring the first virtual object message to be displayed in the second message queue, in which the request message includes combo group information of a virtual object message which is finished to display.

Optionally, the tray controller generates a request message, and the request message includes the last combo group information of the virtual object message which is controlled by the tray controller and is finished to display.

It should be understood that after the tray controller controls the gift tray to display the message, in response to that the queue does not send a virtual object message to the tray controller at the moment, that is, the tray controller is in an idle state at the moment, a request message may be generated, and the request message is actively sent to a tray queue of the first terminal. The request message includes the last combo group information of the virtual object message which is controlled by the tray controller and is finished to display, that is, the request message includes combo group information of the virtual object message which is just finished to displayed, and the combo group information may be a combo group icon.

It should be understood that after the first terminal receives the request message sent by the tray controller, historical virtual object messages to be displayed in the second message queue are acquired.
S720, in response to that the combo group information of the first virtual object message to be displayed is identical to the combo group information of the virtual object message which is finished to display, displaying the first virtual object message to be displayed.

The first historical virtual object message to be displayed is displayed based on a tray controller, and the tray controller is a controller for displaying the virtual object message which is finished to display.

It should be understood that based on the S710, in response to that the acquired combo group information of the virtual object message to be displayed in the second message queue is identical to the combo group information of the virtual object message which is finished to display, the virtual object message to be displayed is returned to the tray controller, that is, the virtual object messages corresponding to the same terminal are sent to the same tray controller for display, jump display is carried out, and the target combo count in the first virtual object message to be displayed is directly displayed. For example, the target combo count in the virtual object message which is finished to display is 10, the combo group information of the virtual object message to be displayed in the second message queue is identical to the combo group information of the virtual object message which is finished to display, the target combo count in the virtual object message to be displayed is 15; and after the tray controller receives the virtual object message to be displayed, the displayed target combo count is 25, that is, the target combo count 10 is directly jumped to the target combo count 25.

According to the message processing method provided by the embodiments of the present disclosure, after the tray controller controls the gift tray to end display, a request message is sent to the queue to actively request to acquire a message that has not been displayed and is identical to the combo group information in the currently ended displayed message, so that the display speed of the same combo group information can be increased.

Based on the above-mentioned embodiments, FIG. 8 is a message processing method provided by the embodiments of the present disclosure, and the method is applied to the first terminal and includes the following steps S810 to S880 shown in FIG. 8.
S810, receiving a target virtual object message.

It should be understood that a terminal receives the target virtual object message.
S820, determining whether the target virtual object message is a virtual object message corresponding to a virtual object sending request from the first terminal.

It should be understood that based on the above-mentioned step S810, after the first terminal receives the target virtual object message, whether the target virtual object message is a virtual object message corresponding to a virtual object sending request sent by the first terminal is determined; in response to yes, step S830 is performed; and in response to not, the virtual object message is added to the second message queue of the first terminal, and step S850 is performed.
S830, adding the target virtual object message to the first message queue.

It should be understood that based on the above-mentioned S820, in response to determining that the virtual object message is sent by the first terminal, the virtual object message is added to the first message queue of the first terminal.
S840, transmitting the virtual object message in the first message queue to a tray controller of the first terminal.

It should be understood that based on the above-mentioned S830, in response to that the message sent by the first terminal itself exists in the first message queue, the first virtual object message in the first message queue is transmitted to the tray controller of the first terminal, and the tray controller is used to control a gift tray of the first terminal to display virtual object information in the message.
S850, determining whether a historical virtual object message which is identical to the combo group information in the target virtual object message exists in the second message queue.

It should be understood that based on the above-mentioned S820, in response to determining that the target virtual object message is a virtual object message corresponding to a virtual object sending request sent by the second terminal, that is, a message sent by another user watching the live streaming room through the terminal, then whether a historical virtual object message which is identical to the target combo group information in the target virtual object message exists in the second message queue of the first terminal is determined, that is, other messages with the same combo group icon as the currently received message are searched in the second message queue.
S860, adding the target virtual object message to a proper position of the second message queue.

It should be understood that based on the above-mentioned S850, in response to that the historical virtual object message which is identical to the combo group icon in the target virtual object message does not exist in the second message queue, the target virtual object message is directly added to the proper position of the second message queue.
S870, taking out the historical virtual object message from the second message queue.

It should be understood that based on the above-mentioned S850, in response to that the historical virtual object message which is identical to the combo group icon in the target virtual object message exists in the second message queue, the historical virtual object message is taken out from the second message queue.
S880, determining a target combo count according to the combo count in the target virtual object message and the combo count in the historical virtual object message, and updating the combo count in the target virtual object message using the target combo count.

It should be understood that based on the above-mentioned S870, the combo count in the target virtual object message and the combo count in the historical virtual object message are acquired; the sum of the two combo counts is calculated and the target combo count is determined; the combo count in the target virtual object message is updated using the target combo count, other information except the combo count in the target virtual object message is not updated; and after the combo count in the target virtual object message is updated, step S860 is performed.

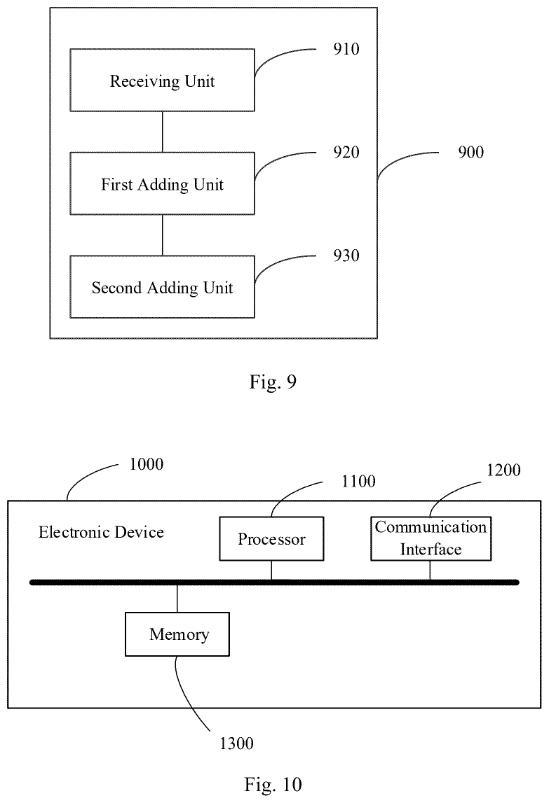

FIG. 9 is a schematic structural diagram of a message processing apparatus provided by the embodiments of the present disclosure. The message processing apparatus provided by the embodiments of the present disclosure is capable of performing the processing flow provided by the embodiment of the message processing method, as shown in FIG. 9, the apparatus 900 includes:
a receiving unit 910 which is configured to receive a target virtual object message;
a first adding unit 920 which is configured to, in response to that the target virtual object message is a virtual object message corresponding to the first terminal, add the target virtual object message to a first message queue; and
a second adding unit 930 which is configured to, in response to that the target virtual object message is a virtual object message corresponding to a second terminal, add the target virtual object message to a second message queue, in which the processing priority corresponding to the first message queue is higher than the processing priority of the second message queue.

Optionally, the apparatus 900 is configured to:
in response to determining that the virtual object message to be displayed does not exist in the first message queue, display the virtual object message to be displayed in the second message queue.

Optionally, the target virtual object message includes target combo group information and target virtual object information.

Optionally, the second adding unit 930 is configured to:
in response to determining that the target virtual object message is the virtual object message corresponding to the second terminal according to target combo group information, determine whether a historical virtual object message corresponding to the target virtual object message exists in the second message queue, in which historical combo group information included in the historical virtual object message corresponding to the target virtual object message is identical to the target combo group information; and
in response to that historical virtual object message corresponding to the target virtual object message does not exist in the second message queue, directly add the target virtual object message to the second message queue.

Optionally, the second adding unit 930 is further configured to:
in response to that the historical virtual object message corresponding to the target virtual object information exists in the second message queue, take out the historical virtual object message corresponding to the target virtual object information from the second message queue;
determine a target combo count corresponding to a target virtual object based on the target virtual object message and the historical virtual object message corresponding to the target virtual object information, and update a combo count in the target virtual object message according to the target combo count corresponding to the target virtual object, thereby obtaining an updated target virtual object message; and
add the updated target virtual object message to the second message queue.

Optionally, the second adding unit 930 is configured to:
determine target value information based on the target combo count corresponding to the target
virtual object message and a value attribute corresponding to each target virtual object;
in response to that at least one historical virtual object message exists in the second message queue, determine a storage position of the target virtual object message in the second message queue according to historical value information corresponding to the at least one historical virtual object message in the second message queue and the target value information; and
add the target virtual object message to the storage position in the second message queue.

Optionally, the second adding unit 930 is configured to:
sort the historical value information corresponding to at least one historical virtual object message in the second message queue and the target value information;
during the sorting process, in response to that there exists historical value information identical to the target value information, acquire a generation time of a target virtual object message corresponding to the target value information and a generation time of a historical virtual object message corresponding to the historical value information identical to the target value information; and
determine the storage position of the target virtual object message in the second message queue according to the generation time of the target virtual object message and the generation time of the historical virtual object message.

Optionally, the apparatus 900 is further configured to:
in response to that a currently displayed virtual object message is of a video type, acquire a next virtual object message to be displayed of a non-video type in the second message queue or the first message queue, and display the next virtual object message to be displayed; or
in response to that the currently displayed virtual object message is of the non-video type, acquire a next virtual object message to be displayed in the second message queue or the first message queue, and display the next virtual object message to be displayed.

Optionally, after adding the target virtual object message to the first message queue, the apparatus 900 is further configured to:
display virtual object messages to be displayed in the first message queue.

Optionally, the apparatus 900 is configured to:
acquire a target combo count corresponding to a first virtual object message to be displayed in the first message queue, and determine a current combo count corresponding to the first virtual object message to be displayed; and
during a process of displaying virtual object information in the first virtual object message to be displayed, simultaneously display a dynamic effect corresponding to the current combo count gradually increasing to the target combo count.

Optionally, the apparatus 900 is configured to:
acquire a target combo count corresponding to a first virtual object message to be displayed in the second message queue, and during a process of displaying virtual object information in the first virtual object message to be displayed, simultaneously display the target combo count.

Optionally, after the display of the virtual object information ends, the apparatus 900 is further configured to:
receive a request message, and acquire the first virtual object message to be displayed in the second message queue, in which the request message includes combo group information of a virtual object message which is finished to display; and
in response to that combo group information of the first virtual object message to be displayed is identical to the combo group information of the virtual object message which is finished to display, display the first virtual object message to be displayed.

The message processing apparatus of the embodiment shown in FIG. 9 can be used to perform the technical solutions of the above-mentioned method embodiments, and its implementation principle and technical effects are similar to the above-mentioned method embodiments, and will not be repeated here.

FIG. 10 is a schematic structural diagram of an electronic device provided by the embodiments of the present disclosure. The electronic device provided in the embodiment of the present disclosure is capable of performing the processing flow provided by the above-mentioned embodiments, as shown in FIG. 10, the electronic device 1000 includes a processor 1100, a communication interface 1200 and a memory 1300; and a computer program is stored in the memory 1300 and is configured to be executed by the processor 1100 to perform the message processing method as described above.

In addition, the embodiments of the present disclosure further provide a computer-readable storage medium on which a computer program is stored, and the computer program is configured to be executed by a processor to implement the message processing method described in the above-mentioned embodiments.

In addition, the embodiments of the present disclosure further provide a computer program product which includes a computer program or instruction, and the computer program or instruction, when executed by a processor, implements the message processing method as described above.

It should be noted that in the present disclosure, relational terms such as “first,” “second,” etc. are only used to distinguish one entity or operation from another entity or operation, and do not necessarily require or imply the existence of any actual relationship or order between these entities or operations. Furthermore, the terms “comprise,” “comprising,” “include,” “including,” etc., or any other variant thereof are intended to cover non-exclusive inclusion, such that a process, method, article or device comprising a set of elements includes not only those elements, but also other elements not expressly listed, or other elements not expressly listed for the purpose of such a process, method, article or device, or elements that are inherent to such process, method, article or device. Without further limitation, an element defined by the phrase “includes a . . . ” does not preclude the existence of additional identical elements in the process, method, article or device that includes the element.

The above descriptions are only specific embodiments of the present disclosure, enabling those skilled in the art to understand or implement the present disclosure. Various modifications to these embodiments will be readily apparent to those skilled in the art, and the generic principles defined herein may be practiced in other embodiments without departing from the spirit or scope of the present disclosure. Therefore, the present disclosure is not to be limited to the embodiments described herein but is to be accorded the widest scope consistent with the principles and novel features disclosed herein.

1. A message processing method, applied to a first terminal, comprising:
receiving a target virtual object message;
in response to that the target virtual object message is a virtual object message corresponding to the first terminal, adding the target virtual object message to a first message queue; and
in response to that the target virtual object message is a virtual object message corresponding to a second terminal, adding the target virtual object message to a second message queue,
wherein a processing priority corresponding to the first message queue is higher than a processing priority corresponding to the second message queue.

2. The message processing method according to claim 1, wherein the target virtual object message comprises target combo group information and target virtual object information; and
in response to that the target virtual object message is a virtual object message corresponding to the second terminal, adding the target virtual object message to the second message queue comprises:
in response to determining that the target virtual object message is the virtual object message corresponding to the second terminal according to target combo group information, determining whether a historical virtual object message corresponding to the target virtual object message exists in the second message queue, wherein historical combo group information comprised in the historical virtual object message corresponding to the target virtual object message is identical to the target combo group information; and
in response to that historical virtual object message corresponding to the target virtual object message does not exist in the second message queue, adding the target virtual object message to the second message queue.

3. The message processing method according to claim 2, further comprising:
in response to that the historical virtual object message corresponding to the target virtual object information exists in the second message queue, taking out the historical virtual object message corresponding to the target virtual object information from the second message queue;
determining a target combo count corresponding to a target virtual object based on the target virtual object message and the historical virtual object message corresponding to the target virtual object information, and updating a combo count in the target virtual object message according to the target combo count corresponding to the target virtual object, thereby obtaining an updated target virtual object message; and
adding the updated target virtual object message to the second message queue.

4. The message processing method according to claim 1, wherein the adding the target virtual object message to the second message queue comprises:
determining target value information based on the target combo count corresponding to the target virtual object message and a value attribute corresponding to each target virtual object;
in response to that at least one historical virtual object message exists in the second message queue, determining a storage position of the target virtual object message in the second message queue according to historical value information corresponding to the at least one historical virtual object message in the second message queue and the target value information; and
adding the target virtual object message to the storage position in the second message queue.

5. The message processing method according to claim 4, wherein the determining the storage position of the target virtual object message in the second message queue according to the historical value information corresponding to the at least one historical virtual object message in the second message queue and the target value information, comprises:
sorting the historical value information corresponding to at least one historical virtual object message in the second message queue and the target value information;
during the sorting process, in response to that there exists historical value information identical to the target value information, acquiring a generation time of a target virtual object message corresponding to the target value information and a generation time of a historical virtual object message corresponding to the historical value information identical to the target value information; and
determining the storage position of the target virtual object message in the second message queue according to the generation time of the target virtual object message and the generation time of the historical virtual object message.

6. The message processing method according to claim 1, wherein after adding the target virtual object message to the first message queue, the message processing method further comprises:
displaying virtual object messages to be displayed in the first message queue.

7. The message processing method according to claim 6, wherein the displaying the virtual object messages to be displayed in the first message queue comprises:
acquiring a target combo count corresponding to a first virtual object message to be displayed in the first message queue, and determining a current combo count corresponding to the first virtual object message to be displayed; and
during a process of displaying virtual object information in the first virtual object message to be displayed, simultaneously displaying a dynamic effect corresponding to the current combo count gradually increasing to the target combo count.

8. The message processing method according to claim 1, further comprising:
in response to determining that there is no virtual object message to be displayed in the first message queue, displaying virtual object messages to be displayed in the second message queue.

9. The message processing method according to claim 8, wherein the displaying the virtual object messages to be displayed in the second message queue comprises:
acquiring a target combo count corresponding to a first virtual object message to be displayed in the second message queue, and during a process of displaying virtual object information in the first virtual object message to be displayed, simultaneously displaying the target combo count.

10. The message processing method according to claim 8, wherein after display of virtual object message currently in a display state ends, the message processing method further comprises:
receiving a request message, and acquiring the first virtual object message to be displayed in the second message queue, wherein the request message comprises combo group information of a virtual object message which is finished to display; and
in response to that combo group information of the first virtual object message to be displayed is identical to the combo group information of the virtual object message which is finished to display, displaying the first virtual object message to be displayed.

11. The message processing method according to claim 6, further comprising:
in response to that a type corresponding to a currently displayed virtual object message is a video type, acquiring a next virtual object message to be displayed of a non-video type in the second message queue or the first message queue, and displaying the next virtual object message to be displayed; or
in response to that the type corresponding to the currently displayed virtual object message is the non-video type, acquiring a next virtual object message to be displayed in the second message queue or the first message queue, and displaying the next virtual object message to be displayed.

12. (canceled)

13. An electronic device, comprising:
a memory;
a processor; and
a computer program,
wherein the computer program is stored in the memory and is configured to be executed by the processor to implement a message processing method, and the message processing method comprises:
receiving a target virtual object message;
in response to that the target virtual object message is a virtual object message corresponding to the first terminal, adding the target virtual object message to a first message queue; and
in response to that the target virtual object message is a virtual object message corresponding to a second terminal, adding the target virtual object message to a second message queue,
wherein a processing priority corresponding to the first message queue is higher than a processing priority corresponding to the second message queue.

14. A non-transitory computer-readable storage medium on which a computer program is stored, wherein the computer program is configured to be executed by a processor to implement a message processing method, and the message processing method comprises:
receiving a target virtual object message;
in response to that the target virtual object message is a virtual object message corresponding to the first terminal, adding the target virtual object message to a first message queue; and
in response to that the target virtual object message is a virtual object message corresponding to a second terminal, adding the target virtual object message to a second message queue,
wherein a processing priority corresponding to the first message queue is higher than a processing priority corresponding to the second message queue.

15. The message processing method according to claim 2, wherein the adding the target virtual object message to the second message queue comprises:
determining target value information based on the target combo count corresponding to the target virtual object message and a value attribute corresponding to each target virtual object;
in response to that at least one historical virtual object message exists in the second message queue, determining a storage position of the target virtual object message in the second message queue according to historical value information corresponding to the at least one historical virtual object message in the second message queue and the target value information; and
adding the target virtual object message to the storage position in the second message queue.

16. The message processing method according to claim 3, wherein the adding the target virtual object message to the second message queue comprises:
determining target value information based on the target combo count corresponding to the target virtual object message and a value attribute corresponding to each target virtual object;
in response to that at least one historical virtual object message exists in the second message queue, determining a storage position of the target virtual object message in the second message queue according to historical value information corresponding to the at least one historical virtual object message in the second message queue and the target value information; and
adding the target virtual object message to the storage position in the second message queue.

17. The message processing method according to claim 15, wherein the determining the storage position of the target virtual object message in the second message queue according to the historical value information corresponding to the at least one historical virtual object message in the second message queue and the target value information, comprises:
sorting the historical value information corresponding to at least one historical virtual object message in the second message queue and the target value information;
during the sorting process, in response to that there exists historical value information identical to the target value information, acquiring a generation time of a target virtual object message corresponding to the target value information and a generation time of a historical virtual object message corresponding to the historical value information identical to the target value information; and
determining the storage position of the target virtual object message in the second message queue according to the generation time of the target virtual object message and the generation time of the historical virtual object message.

18. The message processing method according to claim 16, wherein the determining the storage position of the target virtual object message in the second message queue according to the historical value information corresponding to the at least one historical virtual object message in the second message queue and the target value information, comprises:
sorting the historical value information corresponding to at least one historical virtual object message in the second message queue and the target value information;
during the sorting process, in response to that there exists historical value information identical to the target value information, acquiring a generation time of a target virtual object message corresponding to the target value information and a generation time of a historical virtual object message corresponding to the historical value information identical to the target value information; and
determining the storage position of the target virtual object message in the second message queue according to the generation time of the target virtual object message and the generation time of the historical virtual object message.

19. The message processing method according to claim 5, wherein after adding the target virtual object message to the first message queue, the message processing method further comprises:
displaying virtual object messages to be displayed in the first message queue.

20. The message processing method according to claim 19, wherein the displaying the virtual object messages to be displayed in the first message queue comprises:
acquiring a target combo count corresponding to a first virtual object message to be displayed in the first message queue, and determining a current combo count corresponding to the first virtual object message to be displayed; and
during a process of displaying virtual object information in the first virtual object message to be displayed, simultaneously displaying a dynamic effect corresponding to the current combo count gradually increasing to the target combo count.

21. The message processing method according to claim 9, wherein after display of virtual object message currently in a display state ends, the message processing method further comprises:
receiving a request message, and acquiring the first virtual object message to be displayed in the second message queue, wherein the request message comprises combo group information of a virtual object message which is finished to display; and
in response to that combo group information of the first virtual object message to be displayed is identical to the combo group information of the virtual object message which is finished to display, displaying the first virtual object message to be displayed.
